(19) United States
(12) Patent Application Publication
(10) Pub. No.: US 2025/0270746 A1
(43) Pub. Date: Aug. 28, 2025

(54) STABILIZED FABRICS

(71) Applicant: Owens Corning Intellectual Capital, LLC, Toledo, OH (US)

(72) Inventor: Chloé Bertrand, Marcq en Baroeul (FR)

(21) Appl. No.: 18/859,232

(22) PCT Filed: Apr. 21, 2023
(86) PCT No.: PCT/EP2023/060528

§ 371 Date: Oct. 23, 2024

(30) Foreign Application Priority Data
May 4, 2022 (EP) 22305665.6

(51) Int. Cl. D04H 1/52; B32B 5/02; B32B 5/26; B32B 7/09; D02G 3/18; D02G 3/24; D02G 3/34; D04H 1/4218; D04H 1/4374; D04H 1/74

(52) U.S. Cl. CPC D04H 1/52; B32B 5/022; B32B 5/266; B32B 7/09; D02G 3/18; D02G 3/24; D02G 3/34; D04H 1/4218; D04H 1/4374; D04H 1/74; B32B 2262/101; B32B 2262/106; B32B 2307/718; B32B 2307/737; D10B 2505/02

(57) ABSTRACT

Described herein is a fabric comprising: first fibers oriented in a first direction; second fibers oriented in a second direction; and a stitching yarn maintaining the first and second fibers in their respective orientations, the second direction being different to the first direction, wherein the first fibers comprise glass fibers and/or carbon fibers, and the second fibers are a texturized yarn.

### FIELD OF THE INVENTION

The present invention relates to fabrics comprising glass fibers and/or carbon fibers, in particular fabrics useful to be combined with reinforcement elements in structural components such as wind turbine blades or related components such as a spar cap. In particular, the present invention relates to non-crimp fabrics comprising glass fibers and/or carbon fibers along with a texturized yarn. The present invention also relates to the use of texturized yarn to stabilize non-crimp fabrics.

### BACKGROUND

It is known to use glass and/or carbon fibers to form reinforcement fabrics to reinforce structural components such as wind turbine blades or related components (e.g. spar caps).

Structural components containing reinforcement fabrics (reinforced structural components) are often formed by stacking layers of reinforcement fabrics in a mold, filling the mold with a resin, and curing the resin to form the component. This process can be time consuming. Attempts have been made to improve efficiency of production of reinforced structural components, including pre-cutting reinforcement fabrics and the formation of stacked layers of pre-cut reinforcement fabrics before reinforced structural components are assembled. However, difficulties have been found in relation to the handleability and stability of reinforcement fabrics, particularly when transporting stacked layers of pre-cut reinforcement fabrics. Such difficulties in relation to the handleability and stability of reinforcement fabrics may lead to deformation of the fabrics which may then require additional effort to correct fabric dimensions and reorientate the fabric layers. In addition to the increased lay-up time, issues in relation to handleability and stability of reinforcement fabrics may increase wastage of fabric or lead to detrimental effects on mechanical performance of structural components.

Wind power and the use of wind turbines have gained increased attention as the quest for alternative energy sources continues. With increasing interests in generating more energy from wind power, technological advances in the art have allowed for increased sizes of wind turbines blades. Increasing the size of wind turbine blades also increases the time required to produce the wind turbine blades.

It would be desirable to provide a reinforcement fabric that is dimensionally stable and also resistant to handling to allow the efficiency of the production of wind turbine blades or related components to be improved.

### SUMMARY OF THE INVENTION

At its most general, the present invention provides a non-crimp fabric comprising glass fibers and/or carbon fibers in combination with a texturized yarn.

The present inventors have found that the present invention allows the provision of easy to handle and dimensionally stable fabrics which are useful in the production of wind turbine blades or related components. The present inventors have also found that the provision of such fabrics improves the efficiency of production of the wind turbine blades or related components.

In a first aspect, the present invention provides a fabric comprising:
first fibers oriented in a first direction;
second fibers oriented in a second direction; and
a stitching yarn maintaining the first and second fibers in their respective orientations, the second direction being different to the first direction,
   wherein the first fibers comprise glass fibers and/or carbon fibers, and the second fibers are a texturized yarn.

In a second aspect, the present invention provides a method of providing a fabric, the method comprising:
providing a first structural layer comprising first fibers oriented in a first direction, the first fibers comprising glass fibers and/or carbon fibers;
providing a first stabilization layer comprising second fibers oriented in a second direction, the second fibers being texturized yarn, the second direction being different to the first direction; and
stitching the first structural layer and first stabilization layers together using a stitching yarn to form the fabric.

In a third aspect, the present invention provides the use of a texturized yarn, for example a texturized glass yarn, to improve the stability of a non-crimp fabric comprising glass fibers and/or carbon fibers.

In a fourth aspect, the present invention provides a composite article comprising a fabric described herein.

The invention includes the combination of the aspects and preferred features described herein except where such a combination is clearly impermissible or expressly avoided.

### BRIEF DESCRIPTION OF THE FIGURES

Embodiments and experiments illustrating the principles of the invention will now be discussed with reference to the accompanying figures in which:

FIG. 1 is a schematic diagram of a cross-section through a texturized yarn;

FIG. 2 is a schematic diagram showing a fabric according to an embodiment of the invention;

FIG. 3 is a schematic diagram showing the production of a fabric according to an embodiment of the invention; and

FIG. 4 is a graph that shows the results of the unrolling without flipping test performed on fabrics described herein.

### DETAILED DESCRIPTION

Aspects and embodiments of the present invention will now be discussed with reference to the accompanying figures. Further aspects and embodiments will be apparent to those skilled in the art. All documents mentioned in this text are incorporated herein by reference.

The fabrics described herein may comprise glass fibers. The term “glass fibers” is used herein to refer to a plurality of continuous glass filaments (the term “continuous” as used here is used to refer to a fiber/filament that has a length many times longer than its diameter, for example at least about 5000 times longer than its diameter, e.g. at least about 10 000 times longer than its diameter). The glass fibers used in the fabrics described herein may be provided as glass fiber strands (or tows). The glass fibers described herein may have a sizing on their surface, for example a sizing that was applied to the glass fibers during their formation. The sizing can include components such as a film former, lubricant, coupling agent (to promote compatibility between the glass fibers and the resin used to form a composite article comprising the fabric described herein), etc. that facilitate formation of the glass fibers and/or use thereof in a matrix resin. In some embodiments, the glass fibers include a polyester compatible sizing or an epoxy compatible sizing.

The term “glass fiber strand” or “glass fiber tow” as used herein, refers to a bundle of continuous glass filaments. In embodiments the glass fiber strands or tows are bundles of untwisted glass filaments.

In embodiments, glass fiber strands or glass fiber tows are provided from glass fiber direct rovings. Glass fiber direct rovings are made up of a bundle of continuous untwisted (i.e. substantially parallel, or parallel) glass filaments bonded (as the glass filaments are formed) into a single strand and wound onto a bobbin.

Any suitable glass reinforcing fibers may be employed as the glass fibers described herein, for example as the first and/or fourth fibers, for example, glass fibers made from E glass, E-CR glass (such as Advantex™ glass fibers available from Owens Corning), C glass, H glass, S glass, and AR glass types can be used.

In embodiments, the glass fibers referred to herein (for example, the first and/or third and/or fourth fibers which may comprises, consist essentially of or consist of glass fibers) have a linear mass density in the range of about 50 Tex to about 5000 Tex, for example about 200 Tex to about 4800 Tex, about 300 Tex to about 2500 Tex, about 300 Tex to about 2400 Tex, or about 600 Tex to about 1200 Tex.

The term “texturized yarn” refers to a strand of fibers, e.g. glass fibers, comprising, consisting essentially of or consisting of a bundle of continuous filaments (for example, an unbonded bundle of continuous filaments) which have been texturized in a turbulent stream of compressed air. A schematic diagram of a cross-section through a “texturized yarn”, e.g. a texturized glass yarn, is shown in FIG. 1.

The term “texturized glass yarn” refers to a strand of glass fibers comprising, consisting essentially of or consisting of a bundle of continuous glass filaments (for example, an unbonded bundle of continuous glass filaments) which have been texturized in a turbulent stream of compressed air. The glass filaments forming a texturized glass yarn may be made from E glass, E-CR glass (such as Advantex™ glass), H glass, S glass, or AR glass types. An example of a suitable texturized glass yarn is ECT9 T140 K252C (available from Vetrotex™). A schematic diagram of a cross-section through a “texturized glass yarn” is shown in FIG. 1.

FIG. 1 shows a texturized yarn, e.g. a texturized glass yarn, 104a comprising bulked sections B, for example bulked sections B having a diameter de. The bulked sections B of the texturized yarn, e.g. texturized glass yarn, are formed as a bundle of continuous filaments (e.g. a bundle of continuous glass filaments such as a strand of glass filaments) are passed through a turbulent stream of compressed air. The texturized yarn, e.g. texturized glass yarn, 104a shown in FIG. 1 shows bulked sections B having a diameter dB interspersed with unbulked sections S having a diameter d₅. Diameter d₅ may correspond to the minimum diameter of the texturized yarn, e.g. texturized glass yarn. Diameter dB may be a diameter at least 10% greater than the minimum diameter of the texturized yarn, e.g. texturized glass yarn. Therefore, in embodiments, a “texturized yarn” (e.g. texturized glass yarn) refers to a strand of fibers (e.g. strand of glass fibers) comprising a plurality of bulked sections, for example the bulked sections being formed on exposure of the strand of fibers to a turbulent stream of compressed air. The diameter de or d₅ may be determined by laying a strand of texturized yarn (e.g. texturized glass yarn) in a straight line on a flat surface with no tension applied to the texturized yarn, and measuring the diameter in a bulked or unbulked section respectively using, for example a measuring rule, by measuring the width of the texturized yarn perpendicular to the length of the texturized yarn. The minimum diameter may be taken to be the minimum diameter for a given length of the texturized yarn (e.g. texturized glass yarn), for example the minimum diameter in a 10 cm length of the texturized yarn (e.g. texturized glass yarn), or the minimum diameter of the texturized yarn (e.g. texturized glass yarn) along the length of texturized yarn (e.g. texturized glass yarn) in the fabric.

The fabrics described herein may comprise carbon fibers. The term “carbon fibers” is used herein to refer to a plurality of continuous carbon filaments (the term “continuous” as used here is used to refer to a fiber/filament that has a length many times longer than its diameter, for example at least about 5000 times longer than its diameter, e.g. at least about 10 000 times longer than its diameter). The carbon fibers used in the fabrics described herein may be provided as carbon fiber tows (or strands) which are bundles of continuous carbon filaments. The carbon fibers described herein may have a sizing on their surface, e.g. the carbon fibers have a sizing applied on the carbon fibers during formation of the fibers. The sizing can include components such as a film former, lubricant, coupling agent (to promote compatibility between the carbon fibers and the resin used to form a composite article comprising the fabric described herein), etc. that facilitate formation of the carbon fibers and/or use thereof in a matrix resin. In some embodiments, the carbon fibers include a polyester compatible sizing or an epoxy compatible sizing.

In embodiments, the carbon fibers (where present) have a linear mass density in the range of about 100 Tex to about 5000 Tex, for example about 200 Tex to about 5000 Tex, about 400 Tex to about 5000 Tex, about 600 Tex to about 5000 Tex, about 800 Tex to about 5000 Tex, about 100 Tex to about 4800 Tex, about 200 Tex to about 4800 Tex, about 400 Tex to about 4800 Tex, about 600 Tex to about 4800 Tex, about 800 Tex to about 4800 Tex, about 100 Tex to about 2400 Tex, about 200 Tex to about 2400 Tex, about 400 Tex to about 2400 Tex, about 100 Tex to about 2000 Tex, about 200 Tex to about 2000 Tex, about 400 Tex to about 2000 Tex, about 600 Tex to about 2000 Tex, about 800 Tex to about 2000 Tex, or about 1200 Tex.

In embodiments, carbon fibers (where present) are provided by carbon fiber tows (strands of carbon fibers). In embodiments, the carbon fiber tows have a size in the range of 6K to 50K, for example 6K to 24K, or 6K to 12K. For example, the first fibers may be fed from one or more carbon fiber tows having a size in the range of 6K to 50K, for example 6K to 24K, or 6K to 12K. The nomenclature #K means that the carbon tow is made up of #×1,000 individual carbon filaments, i.e. a carbon fiber tow having a size of 6K is made up of approximately 6000 carbon fiber filaments/fibers.

The present invention provides a fabric comprising a first fibers oriented in a first direction and second fibers oriented in a second direction. The fabric is a non-crimp fabric, the first and second fibers are maintained in their respective orientations with a stitching yarn (as opposed to the first and second fibers being woven together, i.e. a non-crimp fabric is a non-woven fabric).

In embodiments, the second direction is within about 0 degrees to about 90 degrees of the first direction, for example the second direction is within about 10 degrees to about 90 degrees of the first direction, about 15 degrees to about 90 degrees of the first direction, about 25 degrees to about 90 degrees of the first direction, for example, the second direction may be within about 30 degrees to about 90 degrees of the first direction the second direction, within about 45 degrees to about 90 degrees of the first direction.

In embodiments, the fabric has an areal weight in the range of about 200 g/m² to about 2500 g/m², for example about 300 g/m² to about 2000 g/m², about 400 g/m² to about 2000 g/m², about 400 g/m² to about 1500 g/m², about 500 g/m² to about 1500 g/m², about 500 g/m² to about 1300 g/m², or about 750 g/m² to about 2500 g/m². The areal weight of the fiber fabric may be determined according to ISO 3374.

In embodiments, the first fibers oriented in the first direction comprise glass fibers and/or carbon fibers. In embodiments, the first fibers oriented in the first direction comprise glass fibers. In embodiments, the first fibers oriented in the first direction comprise carbon fibers. In embodiments, the first fibers comprise, consist essential of, or consist of glass fibers. In embodiments, the first fibers are glass fibers. In embodiments, the first fibers comprise, consist essentially of, or consist of glass fibers and/or carbon fibers.

The fabric comprises first fibers oriented in a first direction, the first fibers comprising glass fibers and/or carbon fibers.

The fabric comprises second fibers oriented in a second direction, the second fibers being texturized yarn, e.g. texturized glass yarn.

In embodiments, the fabric comprises third fibers oriented in a third direction and/or fourth fibers oriented in a fourth direction.

In embodiments, the fabric comprises:
a first structural layer comprising the first fibers oriented in a first direction;
a first stabilization layer comprising the second fibers oriented in a second direction; and
a stitching yarn maintaining the first and second fibers in their respective orientations, the second direction being different to the first direction.

In embodiments, the fabric comprises:
a first structural layer comprising the first fibers oriented in a first direction;
a first stabilization layer comprising the second fibers oriented in a second direction;
a second stabilization layer comprising third fibers oriented in a third direction and/or a second structural layer comprising fourth fibers oriented in a fourth direction; and
a stitching yarn maintaining the first, second, third and/or fourth fibers in their respective orientations, the second direction being different to the first direction.

In embodiments, the fabric comprises:
A first structural layer comprising the first fibers oriented in a first direction;
a first stabilization layer comprising the second fibers oriented in a second direction; and
a second stabilization layer comprising third fibers oriented in a third direction; and
a stitching yarn maintaining the first, second and third fibers in their respective orientations, the second direction being different to the first direction, optionally the third direction being different to the first and second directions.

In embodiments, the fabric comprises:
a first structural layer comprising the first fibers oriented in a first direction;
a first stabilization layer comprising the second fibers oriented in a second direction;
a second structural layer comprising fourth fibers oriented in a fourth direction; and
a stitching yarn maintaining the first, second and fourth fibers in their respective orientations, the second direction being different to the first direction, optionally the fourth direction being different to the second direction.

In embodiments, the fabric comprises:
a first structural layer comprising the first fibers oriented in a first direction;
a first stabilization layer comprising the second fibers oriented in a second direction;
a second stabilization layer comprising third fibers oriented in a third direction;
a second structural layer comprising fourth fibers oriented in a fourth direction; and
a stitching yarn maintaining the first, second, third and fourth fibers in their respective orientations, the second direction being different to the first direction, optionally the second and third directions being different to the first and fourth directions.

In embodiments, the fabric comprises a first structural layer comprising, consisting essentially of, or consisting of the first fibers oriented in a first direction.

In embodiments, the fabric comprises a first stabilization layer comprising, consisting essentially of, or consisting of the second fibers oriented in a second direction, i.e. the texturized yarn oriented in the second direction.

In embodiments, the fabric comprises a second stabilization layer comprising, consisting essentially of, or consisting of the third fibers oriented in a third direction.

In embodiments, the fabric comprises a second structural layer comprising, consisting essentially of, or consisting of the fourth fibers oriented in a fourth direction.

In embodiments, the fabric comprises a first structural layer, a first stabilization layer, a second stabilization layer and a second structural layer. In embodiments, at least one of the first and second stabilization layers is disposed between the first and second structural layer. In embodiments, the first and second stabilization layers are disposed between the first and second structural layers. In embodiments, the first stabilization layer is disposed between the first and second structural layers and the second structural layer is disposed on the second stabilization layer. In embodiments, the second stabilization layer is disposed between the first and second structural layers and the second structural layer is disposed on the first stabilization layer.

In embodiments, the second direction is different to the first direction and the fourth direction. In embodiments, the second direction is different to the first direction and the fourth direction, and the first direction and the fourth direction differ by at least 45°. In embodiments, the second direction is the same or different to the third direction. In embodiments, the third direction is different to the first direction. In embodiments, the third direction is different to the first direction and the fourth direction. In embodiments, the third direction is different to the first direction and the fourth direction, and the first direction and the fourth direction differ by at least 45°. In embodiments, the third direction is different to the first direction and the fourth direction, and the first direction and the fourth direction differ by at least 45°. In embodiments, the first, second, third and fourth directions are all different to one another.

In embodiments, the fabric comprises:
a first structural layer comprising the first fibers oriented in a first direction;
a first stabilization layer comprising the second fibers oriented in a second direction;
a second stabilization layer comprising third fibers oriented in a third direction;
a second structural layer comprising fourth fibers oriented in a fourth direction; and
a stitching yarn maintaining the first, second, third and fourth fibers in their respective orientations,
   the second and third directions being different to the first and fourth directions, optionally the second and third directions being different and/or the first and fourth directions being different.

The fabric described herein has a fabric length which is defined by the production direction of the fabric. In embodiments, the fabric length (by the production direction of the fabric) is aligned with the stitching direction of the stitching yarn. The fabric length may be described as the “0° direction of the fabric”.

In embodiments, at least one of the second direction and the third direction is substantially perpendicular to the fabric length, i.e. to the 0° direction of the fabric. In embodiments, the second direction is substantially perpendicular to the fabric length, i.e. to the 0° direction of the fabric.

In embodiments, the fabric is a biaxial fabric comprising a first structural layer and a second structural layer wherein the first direction is different from the fourth direction. In embodiments, the fabric comprises a first structural layer and a second structural layer, the first direction being within the range of greater than 0° degrees to about 90° with respect to the 0° direction of the fabric and the fourth direction being within the range of about 0° degrees to about −90° with respect to the 0° direction of the fabric. In embodiments, the fabric comprises a first structural layer and a second structural layer, the first direction being within the range of about 10° degrees to less than about 90° with respect to the 0° direction of the fabric and the fourth direction being within the range of about −10° degrees to less than about −90° with respect to the 0° direction of the fabric. In embodiments, the fabric comprises a first structural layer and a second structural layer, the first direction being within the range of about 45° degrees to about 89° with respect to the 0° direction of the fabric and the fourth direction being within the range of about −45° degrees to about −89° with respect to the 0° direction of the fabric.

In embodiments, the fabric comprises:
a first structural layer comprising the first fibers oriented in a first direction;
a first stabilization layer comprising the second fibers oriented in a second direction;
a second stabilization layer comprising third fibers oriented in a third direction;
a second structural layer comprising fourth fibers oriented in a fourth direction; and
a stitching yarn maintaining the first, second, third and fourth fibers in their respective orientations,
   wherein the first direction is within about 45° to less than about 90° (e.g. about 45° to about 89°) of the 0° direction of the fabric, the fourth direction is within about −45° to less than about −90° (e.g. about −45° to about) −89° of the 0° direction of the fabric, the second direction is substantially perpendicular to the 0° direction of the fabric and the third direction is substantially aligned with the 0° direction of the fabric.

The phrase “substantially perpendicular to the 0° direction of the fabric” may be used herein to refer to a direction in the range of about +/−88° to about 90° with respect to the 0° direction of the fabric, for example a direction in the range of about +/−89° to about 90° with respect to the 0° direction of the fabric.

The phrase “substantially aligned to the 0° direction of the fabric” may be used herein to refer to a direction in the range of about −1° to about 1° with respect to the 0° direction of the fabric, or aligned with the 0° direction of the fabric.

In embodiments, the first fibers and/or the fourth fibers comprise, consist essentially of, or consist of glass fibers and/or carbon fibers.

In embodiments, the first fibers and/or the fourth fibers comprise, consist essentially of, or consist of glass fibers, for examples glass fibers having a linear mass density in the range of about for example about 200 Tex to about 4800 Tex, about 300 Tex to about 2500 Tex, about 300 Tex to about 2400 Tex, or about 600 Tex to about 1200 Tex.

In embodiments, the second fibers are texturized yarn, e.g. texturized glass yarn, for example a texturized yarn as described above (e.g. a texturized yarn as described above in relation to FIG. 1). In embodiments, the texturized glass yarn has a linear mass density in the range of about 30 Tex to about 500 Tex, for example about 50 Tex to about 300 Tex, about 68 Tex to about 280 Tex, about 70 Tex to about 300 Tex, about 70 Tex to about 200 Tex, or about 50 Tex to about 140 Tex.

In embodiments, a “texturized yarn” refers to a strand of fibers comprising a plurality of bulked sections, for example the bulked sections being formed on exposure of the strand of fibers to a turbulent stream of compressed air. In embodiments, a bulked section of a texturized yarn is a section of the texturized yarn having a diameter at least 10% greater than, for example at least 15% greater than, at least 20% greater than, at least 30% greater than, at least 40% greater than, at least 50% greater than, at least 70% greater than, at least 80% greater than, at least 100% greater than, at least 150% greater than, or at least 200% greater than a minimum diameter of the texturized yarn (for example, with unbulked sections of the texturized yarn having a dimeter less than the lowest diameter of the bulked sections). The diameter of sections of the texturized yarn may be measured perpendicular to the length of the yarn. A minimum diameter of the texturized yarn may be defined as the smallest diameter of the texturized yarn for a given section of the texturized fiber, for example the smallest diameter of the texturized yarn in a 10 cm length of the texturized yarn, or the smallest diameter of the texturized yarn along the length of texturized yarn in the fabric.

In embodiments, the texturized yarn (e.g. texturized glass yarn) has a minimum diameter of less than about 5 mm, for example, less than about 4 mm, less than about 3 mm, less than about 2 mm, or about 1 mm or less. In embodiments, the texturized yarn (e.g. texturized glass yarn) has a minimum diameter in the range of about 0.1 mm to about 5 mm, for example about 0.2 mm to about 4 mm, about 0.3 mm to about 3 mm, about 0.5 mm to about 2 mm, about 0.5 mm to about 1.5 mm, or about 0.7 mm to about 1.2 mm, or about 0.8 mm to about 1 mm.

In embodiments, a texturized yarn (e.g. texturized glass yarn) comprises a plurality of bulked sections, each bulked section having a diameter at least 10% greater than (e.g. at least 15% greater than, at least 20% greater than, at least 30% greater than, at least 40% greater than, at least 50% greater than, at least 70% greater than, at least 80% greater than, at least 100% greater than, at least 150% greater than, or at least 200% greater) the minimum diameter of the texturized yarn. In embodiments, a texturized yarn (e.g. texturized glass yarn) comprises a plurality of bulked sections, each bulked section having a diameter in the range of 10% to 600%, 20% to 300%, or 20% to 250%, greater than the minimum diameter of the texturized yarn. In embodiments, a texturized yarn (e.g. texturized glass yarn) comprises a plurality of bulked sections, each bulked section having a diameter of at least 10% greater than (e.g. at least 15% greater than, at least 20% greater than, at least 30% greater than, at least 40% greater than, at least 50% greater than, at least 70% greater than, at least 80% greater than, at least 100% greater than, at least 150% greater than, or at least 200% greater) the minimum diameter of the texturized yarn, and comprises 2 to 30 (for example, 2 to 25, 3 to 30, or 5 to 15) bulked sections per 10 cm length of texturized yarn. In embodiments, a texturized yarn (e.g. texturized glass yarn) comprises a plurality of bulked sections, each bulked section having a diameter of at least 10% greater than (e.g. at least 15% greater than, at least 20% greater than, at least 30% greater than, at least 40% greater than, at least 50% greater than, at least 70% greater than, at least 80% greater than, at least 100% greater than, at least 150% greater than, or at least 200% greater) the minimum diameter of the texturized yarn, and comprises about 2 to about 30, for example about 3 to about 30, about 2 to about 25, or about 5 to about 15 bulked sections per 10 cm length of texturized yarn. The number of bulked sections per 10 cm length of texturized yarn may be determined by laying a strand of texturized yarn (e.g. a strand of texturized glass yarn) in a straight line on a flat surface with no tension applied to the texturized yarn, and counting the number of bulked sections present in a 10 cm length of the texturized yarn wherein the bulked sections are as defined herein.

In embodiments, a texturized yarn (e.g. texturized glass yarn) comprises a plurality of bulked sections, each bulked section having a diameter of at least 10% greater than (e.g. at least 15% greater than, at least 20% greater than, at least 30% greater than, at least 40% greater than, at least 50% greater than, at least 70% greater than, at least 80% greater than, at least 100% greater than, at least 150% greater than, or at least 200% greater) the minimum diameter of the texturized glass yarn, wherein the bulked sections of the texturized glass yarn constitute at least 10%, for example at least 20%, at least 25%, at least 30%, at least 35%, at least 40%, at least 45%, or at least 50% of the length of the texturized yarn.

In embodiments, a texturized yarn (e.g. texturized glass yarn) comprises at least about 2, for example at least about 3 or at least about 5 bulked sections (for example bulked sections as described herein) per 10 cm length of texturized yarn. In embodiments, a texturized yarn (e.g. texturized glass yarn) comprises up to about 30, for example up to about 25, up to about 20 or up to about 15 bulked sections (for example bulked sections as described herein) per 10 cm length of texturized yarn. In embodiments, a texturized yarn (e.g. texturized glass yarn) comprises from about 2 to about 30, for example about 2 to about 25, about 3 to about 30, about 3 to about 20, or about 5 to about 15 bulked sections (for example bulked sections as described herein) per 10 cm length of texturized yarn. The number of bulked sections per 10 cm length of texturized yarn may be determined by laying a strand of texturized yarn (e.g. a strand of texturized glass yarn) in a straight line on a flat surface with no tension applied to the texturized yarn, and counting the number of bulked sections present in a 10 cm length of the texturized yarn wherein the bulked sections are as defined herein.

In embodiments, a texturized yarn (e.g. texturized glass yarn) comprises a plurality of bulked sections (for example bulked sections as described herein), successive bulked sections being spaced by a distance in the range of about 0.5 to about 80 mm, for example about 0.5 to about 50 mm, about 0.5 to about 10 mm, or about 2 to about 8 mm. The distance between successive bulked sections of texturized yarn may be determined by laying a strand of texturized yarn (e.g. a strand of texturized glass yarn) in a straight line on a flat surface with no tension applied to the texturized yarn and using a measuring rule to measure the distance between the end of one bulked section (for example where the diameter of the bulked section reduces to less than 110% of the minimum diameter of the texturized glass yarn) and the beginning of the next bulked section (for example where the diameter of the bulked section increases to 10% greater than the minimum diameter of the texturized glass yarn). In embodiments, the plurality of bulked sections of the texturized yarn are regularly distributed along the texturized yarn, for example the distance between successive bulked sections along the texturized yarn may be approximately the same (for example within about +10%, within about +5%).

In embodiments, the texturized yarn (e.g. texturized glass yarn) comprises a plurality of bulked sections, each bulked section having a diameter in the range of 10% to 600%, 20% to 300%, or 20% to 250%, greater than the minimum diameter of the texturized yarn (e.g. the texturized glass yarn).

In embodiments, the texturized yarn (e.g. texturized glass yarn) comprises a plurality of bulked sections, each bulked section having a diameter of at least 10% greater than (e.g. at least 15% greater than, at least 20% greater than, at least 30% greater than, at least 40% greater than, at least 50% greater than, at least 70% greater than, at least 80% greater than, at least 100% greater than, at least 150% greater than, or at least 200% greater) the minimum diameter of the texturized yarn (e.g. the texturized glass yarn), and comprises about 2 to about 30 (for example about 2 to about 25, about 5 to about 15) bulked sections per 10 cm length of texturized yarn.

In embodiments, the texturized yarn (e.g. texturized glass yarn) comprises a plurality of bulked sections, each bulked section having a diameter of at least 10% greater than (e.g. at least 15% greater than, at least 20% greater than, at least 30% greater than, at least 40% greater than, at least 50% greater than, at least 70% greater than, at least 80% greater than, at least 100% greater than, at least 150% greater than, or at least 200% greater) the minimum diameter of the texturized yarn, and the texturized yarn comprises about 2 to about 30 (for example about 2 to about 25, about 5 to about 15) bulked sections per 10 cm length of texturized yarn.

In embodiments, the texturized yarn (e.g. texturized glass yarn) comprises a plurality of bulked sections, each bulked section having a diameter of at least 10% greater than (e.g. at least 15% greater than, at least 20% greater than, at least 30% greater than, at least 40% greater than, at least 50% greater than, at least 70% greater than, at least 80% greater than, at least 100% greater than, at least 150% greater than, or at least 200% greater) the minimum diameter of the texturized yarn, and the texturized yarn comprises about 2 to about 30 (for example about 2 to about 25, about 5 to about 15) bulked sections per 10 cm length of texturized yarn, wherein successive bulked sections of texturized yarn are spaced by a distance in the range of about 0.5 to about 80 mm, for example about 0.5 to about 50 mm, about 0.5 to about 10 mm, or about 2 to about 8 mm. In embodiments, the bulked sections of the texturized yarn are regularly distributed along the texturized yarn

In embodiments, the texturized yarn (e.g. texturized glass yarn) comprises a plurality of bulked sections, each bulked section having a diameter of at least 10% greater than (e.g. at least 15% greater than, at least 20% greater than, at least 30% greater than, at least 40% greater than, at least 50% greater than, at least 70% greater than, at least 80% greater than, at least 100% greater than, at least 150% greater than, or at least 200% greater) the minimum diameter of the texturized yarn, wherein the bulked sections of the texturized yarn constitute at least 10%, for example at least 20%, at least 25%, at least 30%, at least 35%, at least 40%, at least 45%, or at least 50% of the length of the texturized yarn.

In embodiments, the texturized yarn is a texturized glass yarn, i.e. a strand of glass fibers comprising a plurality of bulked sections, for example the bulked sections being formed on exposure of the strand of glass fibers to a turbulent stream of compressed air.

The second fibers are a texturized glass yarn, for example a texturized glass yarn as described above (e.g. a texturized glass yarn as described above in relation to FIG. 1). An example of a suitable texturized glass yarn is ECT9 T140 K252C (available from Vetrotex™). In embodiments, the texturized glass yarn comprises glass fibers having a diameter in the range of about 5 to about 25 μm, for example about 9 μm to about 24 μm. In embodiments, the texturized glass yarn comprises a plurality of bulked sections, each bulked section having a diameter of at least 10% greater than (e.g. at least 15% greater than, at least 20% greater than, at least 30% greater than, at least 40% greater than, at least 50% greater than, at least 70% greater than, at least 80% greater than, at least 100% greater than, at least 150% greater than, or at least 200% greater) the minimum diameter of the texturized glass yarn. In embodiments, the texturized glass yarn comprises a plurality of bulked sections, each bulked section having a diameter of at least 10% greater than (e.g. at least 15% greater than, at least 20% greater than, at least 30% greater than, at least 40% greater than, at least 50% greater than, at least 70% greater than, at least 80% greater than, at least 100% greater than, at least 150% greater than, or at least 200% greater) the minimum diameter of the texturized glass yarn, wherein the bulked sections of the texturized glass yarn constitute at least 10%, for example at least 20%, at least 25%, at least 30%, at least 35%, at least 40%, at least 45%, or at least 50% of the length of the texturized glass yarn. In embodiments, the e.g. texturized glass yarn comprises a plurality of bulked sections, each bulked section having a diameter of at least 10% greater than (e.g. at least 15% greater than, at least 20% greater than, at least 30% greater than, at least 40% greater than, at least 50% greater than, at least 70% greater than, at least 80% greater than, at least 100% greater than, at least 150% greater than, or at least 200% greater) the minimum diameter of the texturized glass yarn, and the texturized glass yarn comprises about 2 to about 30 (for example about 2 to about 25, about 5 to about 15) bulked sections per 10 cm length of texturized yarn, wherein successive bulked sections of texturized glass yarn are spaced by a distance in the range of about 0.5 to about 80 mm, for example about 0.5 to about 50 mm, about 0.5 to about 10 mm, or about 2 to about 8 mm

In embodiments, the fabric comprises a second stabilization layer comprising third fibers oriented in a third direction. In embodiments, the third fibers comprise, consist essentially of, or consist of glass fibers, for examples glass fibers having a linear mass density in the range of about for example about 50 Tex to about 2400 Tex, about 50 Tex to about 1200 Tex, about 50 Tex to about 600 Tex, about 50 Tex to about 200 Tex, or about 50 Tex to about 140 Tex.

In embodiments, the third fibers comprise, consist essentially of, or consist of glass fibers. In embodiments, the third fibers comprise, consist essentially of, or consist of glass fibers, for examples glass fibers having a linear mass density in the range of about for example about 50 Tex to about 2400 Tex, about 50 Tex to about 1200 Tex, about 50 Tex to about 600 Tex, or about 50 Tex to about 140 Tex. In embodiments, the third fibers are texturized yarn, e.g. texturized glass yarn. In embodiments, the texturized glass yarn has a linear mass density in the range of about 50 Tex to about 200 Tex, or about 50 Tex to about 140 Tex.

In embodiments, the first fibers constitute at least about 25 wt. % of the total weight of the fabric. In embodiments, the first fibers constitute from about 25 wt. % to about 95 wt. % of the total weight of the fabric, for example about 25 wt. % to about 75 wt. %, or about 25 wt. % to about 70 wt. % of the total weight of the fabric.

In embodiments, the first structural layer constitutes at least about 25 wt. % of the total weight of the fabric. In embodiments, the first structural layer constitutes from about 25 wt. % to about 95 wt. % of the total weight of the fabric, for example about 25 wt. % to about 75 wt. %, or about 25 wt. % to about 70 wt. % of the total weight of the fabric.

In embodiments, the fabric comprises a second structural layer and the second structural layer constitutes at least about 25 wt. % of the total weight of the fabric. In embodiments, the second structural layer constitutes from about 25 wt. % to about 75 wt. %, or about 25 wt. % to about 70 wt. % of the total weight of the fabric.

In embodiments, the texturized yarn (e.g. texturized glass yarn) constitutes up to about 25 wt. % of the total weight of the fabric, for example up to about 20 wt. % of the total weight of the fabric, up to about 15 wt. % of the total weight of the fabric, up to about 10 wt. % of the total weight of the fabric, up to about 8 wt. % of the total weight of the fabric, or up to about 5 wt. % of the total weight of the fabric. In embodiments, the texturized yarn (e.g. texturized glass yarn) constitutes from about 0.5 wt. % to about 25 wt. % of the total weight of the fabric, for example from about 0.5 wt. % to about 15 wt. % of the total weight of the fabric, from about 0.5 wt. % to about 10 wt. % of the total weight of the fabric, from about 0.5 wt. % to about 8 wt. % of the total weight of the fabric, or from about 1 wt. % to about 5 wt. % of the total weight of the fabric.

In embodiments, the second fibers constitute up to about 25 wt. % of the total weight of the fabric, for example up to about 20 wt. % of the total weight of the fabric, up to about 15 wt. % of the total weight of the fabric, or up to about 10 wt. % of the total weight of the fabric, up to about 8 wt. % of the total weight of the fabric, or up to about 5 wt. % of the total weight of the fabric. In embodiments, the second fibers constitute from about 0.5 wt. % to about 25 wt. % of the total weight of the fabric, for example from about 0.5 wt. % to about 15 wt. % of the total weight of the fabric, from about 0.5 wt. % to about 10 wt. % of the total weight of the fabric, from about 0.5 wt. % to about 8 wt. % of the total weight of the fabric, or from about 1 wt. % to about 5 wt. % of the total weight of the fabric.

In embodiments, the first stabilization layer constitutes up to about 25 wt. % of the total weight of the fabric, for example up to about 20 wt. % of the total weight of the fabric, up to about 15 wt. % of the total weight of the fabric, or up to about 10 wt. % of the total weight of the fabric. In embodiments, the first stabilization layer constitutes from about 0.5 wt. % to about 25 wt. % of the total weight of the fabric, for example from about 0.5 wt. % to about 15 wt. % of the total weight of the fabric, from about 0.5 wt. % to about 10 wt. % of the total weight of the fabric, from about 0.5 wt. % to about 8 wt. % of the total weight of the fabric, or from about 1 wt. % to about 5 wt. % of the total weight of the fabric.

In embodiments, the second stabilization layer constitutes up to about 25 wt. % of the total weight of the fabric, for example up to about 20 wt. % of the total weight of the fabric, up to about 15 wt. % of the total weight of the fabric, or up to about 10 wt. % of the total weight of the fabric. In embodiments, the second stabilization layer constitutes from about 0.5 wt. % to about 25 wt. % of the total weight of the fabric, for example from about 0.5 wt. % to about 15 wt. % of the total weight of the fabric, from about 0.5 wt. % to about 10 wt. % of the total weight of the fabric, from about 0.5 wt. % to about 8 wt. % of the total weight of the fabric, or from about 1 wt. % to about 5 wt. % of the total weight of the fabric.

In embodiments, glass fibers (for example including texturized glass yarn) constitute at least about 50 wt. % of the total weight of the fabric, for example at least about 60 wt. %, at least about 70 wt. %, at least about 80 wt. %, at least about 90 wt. %, at least about 95 wt. %, or at least about 98 wt. % of the total weight of the fabric.

In embodiments, the stitching yarn constitutes less than about 10 wt. % of the fabric, or less than about 8 wt. % of the fabric. In embodiments, the stitching yarn constitutes from about 0.1 wt. % to about 10 wt. % of the fabric, for example from about 1 wt. % to about 10 wt. %, or from about 2 wt. % to about 8 wt. % of the fabric.

Any suitable stitching yarn may be employed. In embodiments, the stitching yarn is a polyester yarn. In embodiments, the stitching yarn has a linear mass density in the range of about 50 dTex to about 300dTex.

In embodiments, the stitching yarn forms a stitching pattern through the fabric, the stitching pattern may be selected from a tricot stitching pattern, a symmetric double tricot stitching pattern, an asymmetric double tricot stitching pattern, a symmetric diamant stitching pattern, and an asymmetric diamant stitching pattern. In embodiments, the stitching yarn forms a stitching pattern through the fabric, the stitching pattern being a tricot stitching pattern.

In embodiments, the stitching yarn defines a stitching length, the stitching length being in the range of about 2 mm to about 7 mm, for example about 3 mm

In general, the fabric contains no resin, i.e., none of the fibers forming the fabric are pre-impregnated with a resin.

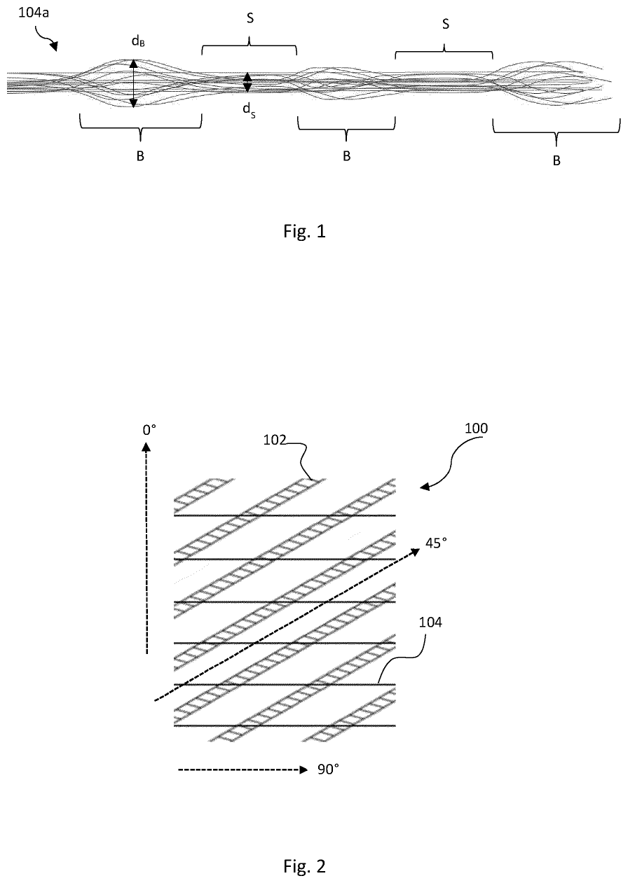

FIG. 2 is a schematic diagram of a fabric 100 which is constructed from first fibers 102 (e.g. glass fiber strands) and second fibers (e.g. texturized glass yarn) 104. The first fibers 102 are oriented in a first direction (45° direction, which is 45° to the 0° direction of the fabric) and the second fibers are oriented in a second direction (90° direction, which substantially perpendicular to the length of the fabric (0° direction shown in FIG. 2)).

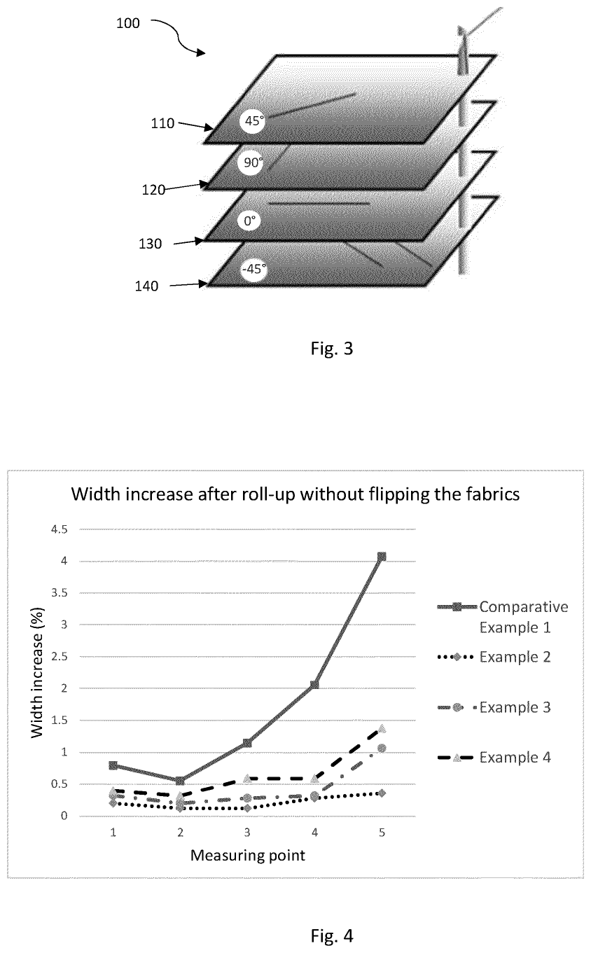

FIG. 3 is a schematic diagram of a fabric 100 which is constructed from a first structural layer 110 formed of first fibers oriented in a first direction (45° direction, which is 45° to the 0° direction of the fabric), a first stabilization layer 120 formed of second fibers oriented in a second direction (90° direction, which substantially perpendicular to the 0° direction of the fabric), a second stabilization layer 130 formed of third fibers oriented in a third direction (0° direction which is aligned with the length of the fabric), and a second structural layer 140 formed of fourth fibers oriented in a fourth direction (−45° direction, which is −45° to the direction of the length of the fabric). In the embodiment shown in FIG. 3, the first and second stabilization layers 120, 130 are disposed between the first and second structural layers 110, 140. Alternative configurations are possible as described herein.

In embodiments, the fabric described herein may be impregnated with a resin and the resin cured to form a composite article.

### EXAMPLES

The following illustrates examples of the fabrics and related aspects described herein. Thus, these examples should not be considered to restrict the present disclosure, but are merely in place to teach how to carry out the processes and obtain the products of the present disclosure.

### Comparative Example 1

A biaxial fabric was produced by providing a first structural layer made up of glass fibers oriented in the 45° direction, a first stabilization layer made up of glass fibers orientated in the 0° direction (i.e. along the length of the fabric), a second stabilization layer made up of glass fibers orientated in the 90° direction (i.e. perpendicular to the length of the fabric), and a second structural layer made up of glass fibers oriented in the −45° direction.

The first structural layer was formed by providing strands of 1200 Tex glass fibres fed from a direct roving (Advantex™ E-CR glass fibers with an epoxy resin compatible sizing, the filaments of the glass fibers having a diameter of 17 μm), the strands of glass fibers were aligned in the 45° direction, with the first structural layer comprising 2.91 glass fiber strands per cm (measured perpendicular to the first direction).

The first stabilization layer was formed by providing strands of 68 Tex glass fibers (E-glass with an epoxy resin compatible sizing, the filaments of the glass fibers having a diameter of <19 μm), the strands of glass fibers were aligned in the 0° direction, with the first stabilization layer comprising 0.30 glass fiber strands per cm.

The second stabilization layer was formed by providing strands of 68 Tex glass fibers (E-glass with an epoxy resin compatible sizing, the filaments of the glass fibers having a diameter of <19 μm) orientated at 90° to the fibers of the first stabilization layer, with the second stabilization layer comprising 0.30 glass fiber strands per cm.

The second structural layer was formed by providing strands of 1200 Tex glass fibres fed from a direct roving (Advantex™ E-CR glass fibers with an epoxy resin compatible sizing, the filaments of the glass fibers having a diameter of 17 μm), the strands of glass fibers were aligned in the −45° direction, with the second structural layer comprising 2.91 glass fiber strands per cm.

The fringes of the fabric formed by the glass fiber strands were cut on the machine <10 mm.

The fabric layers were ordered such that the first and second stabilization layers (layers 2 and 3 in table 1) were disposed between the first and second structural layers (layers 1 and 4 in table 1) and stitched together with the using a polyester stitching yarn having a linear density of 7.6 Tex employing a chain stitching pattern with a stich length of 2.6 mm.

The overall areal weight of the fabric was 998 g/m².

### Example 2

A biaxial fabric was produced by providing a first structural layer made up of glass fibers oriented in the 45° direction, a first stabilization layer made up of texturized glass yarn orientated in the 90° direction (i.e. perpendicular to the length of the fabric), a second stabilization layer made up of glass fibers orientated in the 0° direction (i.e. along the length of the fabric), and a second structural layer made up of glass fibers oriented in the −45° direction.

The first structural layer was formed by providing strands of 1200 Tex glass fibres fed from a direct roving (Advantex™ E-CR glass fibers with an epoxy resin compatible sizing, the filaments of the glass fibers having a diameter of 17 μm), the strands of glass fibers were aligned in the 45° direction, with the first structural layer comprising 2.91 glass fiber strands per cm (measured perpendicular to the first direction).

The first stabilization layer was formed by providing 140 Tex texturized glass yarn (texturized E-glass yarn ECT9 T140 K252C from Vetrotex™ with an epoxy resin compatible sizing) orientated at 90° to the 0° direction of the fabric, the first stabilization layer comprising 0.30 glass fiber strands (texturized glass yarn) per cm. The texturized glass yarn used had a minimum diameter of 0.9 mm, with 12 bulked sections per 10 cm (each bulked section determined as a length of yarn having a diameter, de, (measured perpendicular to the length of the yarn, for example as shown in FIG. 1) of at least 10% greater than the minimum diameter of the yarn (i.e. greater than 1 mm)). The texturized glass yarn used comprised 12 bulked sections per 10 cm and the bulked sections of the texturized glass yarn constituted more than 50% of the length of the texturized glass yarn.

The second stabilization layer was formed by providing strands of 68 Tex glass fibers (E-glass with an epoxy resin compatible sizing, the filaments of the glass fibers having a diameter of <19 μm), the strands of glass fibers were aligned in the 0° direction, with the second stabilization layer comprising 0.30 glass fiber strands per cm.

The second structural layer was formed by providing strands of 1200 Tex glass fibres fed from a direct roving (Advantex™ E-CR glass fibers with an epoxy resin compatible sizing, the filaments of the glass fibers having a diameter of 17 μm), the strands of glass fibers were aligned in the −45° direction, with the second structural layer comprising 2.91 glass fiber strands per cm.

The fabric layers were ordered such that the first and second stabilization layers (layers 2 and 3 in table 1) were disposed between the first and second structural layers (layers 1 and 4 in table 1) and stitched together with the using a polyester stitching yarn having a linear density of 7.6 Tex employing a chain stitching pattern with a stich length of 2.6 mm.

The overall areal weight of the fabric was 1000 g/m².

### Example 3

A biaxial fabric was produced as described in Example 2 except that the order of the first stabilization layer and second structural layer was switched such that the fabric layers were ordered such that the second stabilization layers (layer 2 in table 1) was disposed between the first and second structural layers (layers 1 and 3 in table 1) and the second structural layer (layer 3 in table 1) being disposed on the first stabilization layer (layer 4 in table 1).

### Example 4

A biaxial fabric was produced as described in Example 2 except that the first stabilization layer was formed by providing 0.16 glass fiber strands per cm of 140 Tex texturized glass yarn (texturized E-glass yarn ECT9 T140 K252C from Vetrotex™) orientated at 90° to the fibers of the first stabilization layer.

The overall areal weight of the fabric was 998 g/m².

The fabrics of Comparative Example 1 and Examples 2-4 are summarised in table 1 below. Layers 1-4 referred to in the table designate the order of the layers employed (in numerical order from top to bottom) in each of the examples, with layer 1 being the uppermost layer and layer 4 being the bottom layer.

TABLE 1

| | | C. Exam- | Exam- | Exam- | Exam- |
|---|---|---|---|---|---|
| Layer | | ple 1 | ple 2 | ple 3 | ple 4 |
| 1 | Type of | Glass - | Glass - | Glass - | Glass - |
| | fibers | 1200 Tex | 1200 Tex | 1200 Tex | 1200 Tex |
| | Areal weight | 494 | 494 | 494 | 494 |
| | (g/m²) | | | | |
| | Direction of | 45° | 45° | 45° | 45° |
| | fibers wrt 0° | | | | |
| | direction of | | | | |
| | fabric | | | | |
| 2 | Type of | Glass - | Glass - | Glass - | Glass - |
| | fibers | 68 Tex | 68 Tex | 68 Tex | 68 Tex |
| | Areal weight | 2 | 2 | 2 | 2 |
| | (g/m²) | | | | |
| | Direction of | 0° | 0° | 0° | 0° |
| | fibers wrt 0° | | | | |
| | direction of | | | | |
| | fabric | | | | |
| 3 | Type of | Glass - | Textur- | Glass - | Textur- |
| | fibers | 68 Tex | ized - | 1200 Tex | ized - |
| | | | 140 Tex | | 140 Tex |
| | Areal weight | 2 | 4 | 494 | 2 |
| | (g/m²) | | | | |
| | Direction of | 90° | 90° | −45° | 90° |
| | fibers wrt 0° | | | | |
| | direction of | | | | |
| | fabric | | | | |
| 4 | Type of | Glass - | Glass - | Textur- | Glass - |
| | fibers | 1200 Tex | 1200 Tex | ized - | 1200 Tex |
| | | | | 140 Tex | |
| | Areal weight | 494 | 494 | 4 | 494 |
| | (g/m²) | | | | |
| | Direction of | −45° | −45° | 90° | −45° |
| | fibers wrt 0° | | | | |
| | direction of | | | | |
| | fabric | | | | |
| Stitching | Areal weight | 5 | 5 | 5 | 5 |
| yarn | (g/m²) | | | | |
| | Total areal | 998 | 1000 | 1000 | 998 |
| | weight | | | | |
| | (g/m²) | | | | |

The areal weight of the different components and of the fabrics was determined according to ISO 3374.

### Fabric Stability

The stability of the various biaxial fabrics was tested utilizing several fabric rolling and unrolling strategies.

The example fabrics were unrolled and a 2-meter long sample was cut from each of the fabrics. The 2-meter samples were then rerolled on a cardboard tube with an external diameter of 95 mm. To test the level of deformation, the width of the samples was measured before and after the rerolling at several designated points (at 5 cm, 50 cm, 100 cm, 150 cm, and 195 cm).

FIG. 4 is a graph that shows the results of the unrolling without flipping test performed on the four different samples (Examples 1-4). These results were obtained by taking 3 test samples from each roll and subjecting them to the testing method. The average width increase per measuring point was then obtained. As can be observed, the fabrics of Examples 2-4 all showed an increase in stability compared to the fabric of Comparative Example 1. It can be concluded that the use of a texturized yarn provides a substantial improvement to the fabric dimensional stability.

These tests demonstrate the ability of texturized yarn to improve the dimensional stability and handleability of non-crimp fabrics, in particular biaxial non-crimp fabrics. It is noted that the present inventors have observed similar improvements for unidirectional fabrics containing texturized yarn as described herein.

Conventionally, a skilled person aiming to provide a non-crimp fabric would choose fibers and fiber position in order to optimise fiber alignment which would be expected to optimise mechanical properties of the non-crimp fabric. Therefore, the use of a texturized yarn in a non-crimp fabric, such as the fabrics described herein, goes against the skilled person's understanding of how non-crimp fabrics should be produced (the fibers in a texturized yarn are not all aligned (see, for example, FIG. 1), this non-alignment of the fibers in a texturized yarn allows for the required bulk of the texturized yarn). It is even more surprising that the use of a texturized yarn in the fabrics described herein actually improves the dimensional stability and resistance to handling of the fabrics.

### Impact on Infusion Properties

To ensure the use of texturized yarn provided no detrimental impact on different fabric properties, the infusion properties were also investigated.

### Cross Plane Thickness (CPT)

The CPT Test measures uptake of the resin by the fabric. The focus of this test is to measure the thickness of the resulting infused plate as well as the glass weight fraction of the plate. For this test 20 layers of fabric with 60 by 60 cm dimensions are fully infused with a resin.

Two different fabrics, Comparative Example 1 and Example 2, were assessed using the CPT test using an epoxy resin. The results, shown in Table 2, indicate that resin uptake is not significantly changed by the presence of texturized yarn. Furthermore, it was observed that the fabrics containing texturized glass yarn exhibit excellent infusion time.

TABLE 2

| | Infused thickness (mm) | Glass weight fraction (%) |
|---|---|---|
| C. Example 1 | 0.725 | 73 |
| Example 2 | 0.731 | 73 |

### In Plane Infusion Test (IPIT)

The IP IT test measures the distance covered by the resin over time. A flow front (distance) of the resin is recorded after 2, 4, 6, 8, 10, 12, 16, 20, 26, 32, 38, 44, 50, 55, and 60 minutes. The distance that the resin has travelled through the fabric is referred to as the infusion length. The measured length relative to the infusion time is used as a measure of the rate of infusion of the fabric. The IP IT test can be used to compare the rates of infusion of different fabrics, so long as the other testing parameters are substantially the same.

Two different fabrics, Comparative Example 1 and Example 2, were assessed using the IPIT test in the direction of the 90° orientation (along the length of the texturized yarn) using an epoxy resin. The results of the IPIT test were similar to the CPT test, demonstrating that the fabrics described herein exhibit excellent infusion properties.

1. A fabric comprising:
a plurality of first fibers oriented in a first direction;
a plurality of second fibers oriented in a second direction; and
a stitching yarn maintaining the first and second fibers in their respective orientations, the second direction being different than the first direction,
wherein the first fibers comprise at least one of glass fibers and carbon fibers, and
wherein the second fibers are a texturized yarn.

2. The fabric of claim 1, wherein the texturized yarn constitutes from about 0.5 wt. % to about 10 wt. % of the fabric.

3. The fabric of claim 1, wherein the texturized yarn is a texturized glass yarn.

4. The fabric of claim 1, wherein the texturized yarn has a minimum diameter of less than about 4 mm.

5. The fabric of claim 1, wherein the texturized yarn comprises a plurality of bulked sections, each bulked section having a diameter of at least 10% greater than a minimum diameter of the texturized yarn.

6. The fabric of claim 5, wherein the bulked sections of the texturized yarn constitute at least 10% of the length of the texturized yarn.

7. The fabric of claim 5, wherein the texturized yarn comprises from about 2 to about 30 of the bulked sections per 10 cm length of the texturized yarn.

8. The fabric of claim 1, wherein the texturized yarn comprises a plurality of bulked sections, and wherein successive bulked sections of the texturized yarn are spaced by a distance in the range of about 0.5 mm to about 80 mm.

9. The fabric of claim 1, wherein the second direction is from greater than 0 degrees to about 90 degrees of the first direction.

10. The fabric of claim 1, wherein an areal weight of the fabric is from about 400 g/m² to about 2500 g/m².

11. The fabric of claim 1, wherein the first fibers comprise glass fibers, and wherein the glass fibers constitute at least about 50 wt. % of the total weight of the fabric.

12. The fabric of claim 1, further comprising:
a first structural layer comprising the first fibers oriented in the first direction;
a first stabilization layer comprising the second fibers oriented in the second direction;
a second stabilization layer comprising a plurality of third fibers oriented in a third direction; and
a second structural layer comprising a plurality of fourth fibers oriented in a fourth direction.

13. The fabric of claim 12, wherein the first stabilization layer is disposed between the first structural layer and the second structural layer, and wherein the first and fourth directions are different from the second direction.

14. The fabric of claim 12, wherein the second structural layer is disposed between the first structural layer and the first stabilization layer, and wherein the first and fourth directions are different from the second direction.

15. The fabric of claim 12, wherein the first direction is within about 45° to about 89° of the 0° direction of the fabric, the fourth direction is within about −45° to about −89° of the 0° direction of the fabric, the second direction is substantially perpendicular to the 0° direction of the fabric, and the third direction is substantially aligned with the 0° direction of the fabric.

16. A method of producing a fabric, the method comprising:
providing a first layer comprising a plurality of first fibers oriented in a first direction, the first fibers comprising at least one of glass fibers and carbon fibers;
providing a second layer comprising a plurality of second fibers oriented in a second direction, the second fibers being texturized yarn, the second direction being different from the first direction; and
stitching the first and second layers together using a stitching yarn to form the fabric.

17-18. (canceled)
